(19) United States
(12) Patent Application Publication
(10) Pub. No.: US 2015/0097366 A1
(43) Pub. Date: Apr. 9, 2015

(54) BRAKE LINE ASSEMBLY

(71) Applicant: KODIAK PRODUCTS CO., INC., Fort Worth, TX (US)

(72) Inventors: William E. Glidewell, Lewisville, TX (US); Calvin H. Lin, Plano, TX (US)

(21) Appl. No.: 14/494,690

(22) Filed: Sep. 24, 2014

Related U.S. Application Data
(60) Provisional application No. 61/888,595, filed on Oct. 9, 2013.

(51) Int. Cl. B60T 17/04

(52) U.S. Cl. CPC B60T 17/043
USPC 285/62; 285/256; 285/334.5

(57) ABSTRACT

A brake line assembly including a brake hose and a connector assembly. The connector assembly includes a tube having a portion thereof the tube externally threaded; a flare nut defining a bore and through which the tube is inserted; and a fitting defining a bore configured to receive an end of the brake hose therein. A portion of a wall defining the fitting's bore is disposed adjacent the fitting's first end and is internally threaded. The threaded portion of the tube is engaged therewith. The fitting is disposed a distance from a flare on the tube adjacent a first end of the flare nut and when the flare nut is fixedly engaged with a component of the braking system, the distance between the fitting and the second end of the flare nut is sufficiently large enough to permit a head of a flare-nut wrench to be received therein.

### CROSS-REFERENCE TO RELATED APPLICATION

This application claims the benefit of U.S. Provisional Patent Application No. 61/888,595 filed Oct. 9, 2013, the entire specification of which is incorporated herein by reference.

### BACKGROUND OF THE INVENTION

1. Technical Field

This invention relates generally to braking systems. More particularly, this invention relates to hydraulic brake line assemblies used on trailers and motor vehicles. Specifically, this invention is directed to an improved brake line assembly which tends to be less prone to corrosion, particularly in humid environments, and is configured for easier engagement with a flare-nut wrench during installation or repair procedures.

2. Background Information

Hydraulic brake lines have connector assemblies provided at each end. The connector assemblies are used to engage the brake line with a hydraulic master cylinder, a brake caliper or the like. Typically, the connector assemblies include a carbon steel fitting which is secured to a brake hose and a carbon steel flare nut that is engageable with the master cylinder or the like. A short tube extends between the fitting and the flare nut. Over time, the tube, flare nuts, and fittings may become corroded, especially in regions of the country where they are subjected to moisture or saltwater, or to compounds used to melt snow. This corrosion can result in the brake lines leaking, which in turn may cause the brakes on the trailer or vehicle to fail prematurely. It is fairly typical that flare nuts become seized on the tube or to component parts of the master cylinder or brake caliper. If it becomes necessary to repair or replace the brake line or remove and replace a component (such as a caliper), it can be extremely difficult to loosen the flare nuts without causing damage to the same.

Typically, a flare nut is engaged with or disengaged from the master cylinder or the like by way of a flare-nut wrench. The wrench engages a hexagonal region on the flare nut and then the wrench's handle is moved through an arc to rotate the flare nut about an axis. The locations at which flare nuts are secured to other components in the brake assembly tend to be tight, confined spaces that are difficult to see clearly. Still further, the proximity of the fitting to the flare nut may make it difficult to engage the wrench properly. Additionally, when a new flare is engaged with the appropriate components of the braking system, it is relatively easy to apply too much torque to the flare. Over-torquing of the flare nut can easily lead to a flare on the tube splitting and thereby rendering the entire brake component useless.

Due to the deleterious effect of corrosion on carbon steel, certain brake hose manufacturers have chosen to utilize brass to fabricate the flare. However, since brass is not as strong as steel, the manufacturers have tended to shorten the flare tube (such as is shown in FIG. 1 hereto which shows a PRIOR ART brake line assembly). This use of brass and the shortening of the flare tube has resulted in a flare which is more difficult to access and tends to be easily split during assembly.

### BRIEF SUMMARY OF THE INVENTION

An improved brake line assembly and a method of installing the same are disclosed herein which will tend to avoid or mitigate the issues identified above. The brake line assembly includes a brake hose and a connector assembly. A method of using the same is also disclosed herein.

In one aspect the invention may provide a brake line assembly including a brake hose having first and second ends and defining a bore therebetween; a connector assembly includes a tube having first and second ends and defines a bore therebetween, wherein a portion of the tube is externally threaded and flared at one end; a flare nut having first and second ends and a bore defined therebetween; wherein the flare nut is adapted to engage a female component of the braking system; and wherein the tube is received through the flare nut's bore; and a fitting having first and second ends and a bore defined therebetween, wherein the fitting's bore is adapted to engage an end of a brake hose therein; and wherein at least portion of a wall defining the fitting's bore is disposed adjacent the fitting's first end and is internally threaded and the externally threaded portion of the tube is threadably engaged therewith. The connector assembly may be fabricated entirely or in part utilizing stainless steel. The use of the stainless steel makes the fitting stronger and less prone to corrosion. Additionally, the use of stainless steel has enabled manufacturers to lengthen the tube, thereby making the fitting more accessible and engageable by a flare nut wrench.

In another aspect the invention may provide a method of securing a brake hose to a component of a braking system or disengaging the brake hose therefrom; where the brake hose is fixedly engaged with a connector assembly which includes a fitting that is secured to the hose, a tube extending outwardly from the fitting and terminating in a flare, and a flare nut engaged around the tube and rotatable about an axis extending along the tube; said method comprising the steps of inserting a head of a flare-nut wrench or an open wrench between a first end of the fitting and a second end of the flare nut; positioning the head of the wrench adjacent an exterior surface of a length of the tube disposed between the first end of the fitting and the second end of the flare nut; moving the head of the wrench toward the second end of the flare nut; engaging the head of the wrench with a hexagonal region at the second end of the flare nut; and rotating the flare nut with the wrench about the axis extending through the tube in a first direction to secure the flare nut to the component of the braking system; or in a second direction to disengage the flare nut from the component.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is an elevational view of a PRIOR ART brass brake line assembly including a brake hose and connector assembly;

FIG. 2 is an elevational view of a brake line assembly which includes a brake hose, a stainless steel flare and a brass connector assembly;

FIG. 3 is an elevational sectional view of the brake line assembly of FIG. 2;

FIG. 4 is an elevational view of the brake line assembly with the components of the connector assembly exploded from each other;

FIG. 5 is a elevational view of the brake line assembly in use; and

FIG. 6 is an elevational view of a second embodiment of the brake line assembly.

Similar numbers refer to similar parts throughout the drawings.

### DETAILED DESCRIPTION

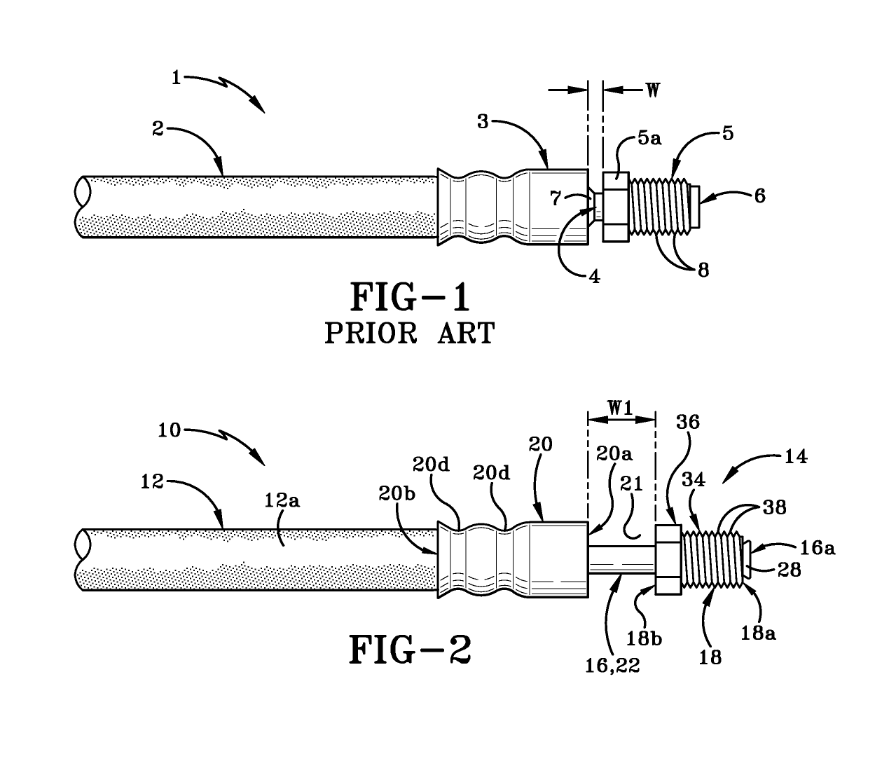

Referring to FIG. 1 there is shown a PRIOR ART brake line assembly 1 comprising a brake hose 2, a fitting 3, a tube 4, and a flare nut 5. Fitting 3 is secured to an end of brake hose 2 by crimping the same thereon. Tube 4 is secured to fitting 3 by brazing 7, for example, and flare nut 5 is secured on tube 4 by a flare 6. Flare nut 5 is used to connect brake hose 2 to another component part of the brake system, such as a master cylinder, a brake caliper, or a brake control valve. Flare nut 5 is free to rotate about an axis that extends along tube 4. In order to tighten flare nut 5 or to loosen the same, it is necessary to engage a hexagonal portion 5a on flare nut 5 with a flare-nut wrench (not shown) or an open wrench (not shown). It should be noted that flare nut 5 is relatively close to fitting 3, being separated therefrom by a length of tube 4 represented by the reference character “W”. Frequently, there is very little room to maneuver the flare-nut wrench or open wrench while tightening or loosening flare nut 5. It can also be quite difficult to see what one is doing while performing this tightening or loosening operation. It is therefore quite easy to over-torque flare nut 5. This can result in flare 6 becoming split or cracked, which then results in the brake line leaking and therefore not functioning properly. As indicated earlier herein, these problems are exacerbated by previously known tubes 4 being fabricated by materials such as brass. Obviously, the possible premature failure of the braking system because of over-torquing presents a real and present danger to the vehicle or trailer operator. Additionally, over-torquing of flare nut 5 can result in threads 8 being stripped or can lead to damage of the faces and corners on the hexagonal region 5a of flare nut 5. This damage to threads 8 or region 5a may make it difficult to remove flare nut 5 at a later date.

Referring to FIGS. 2-4, there is shown a brake line assembly 10 in accordance with an aspect of the invention. Brake line assembly 10 comprises a brake hose 12 and a connector assembly 14. Although not illustrated herein, it will be understood that as with the prior art connector assembly 1, connector assembly 14 is configured for engagement with a female connector provided on another component of a braking system such as a master cylinder or brake caliper.

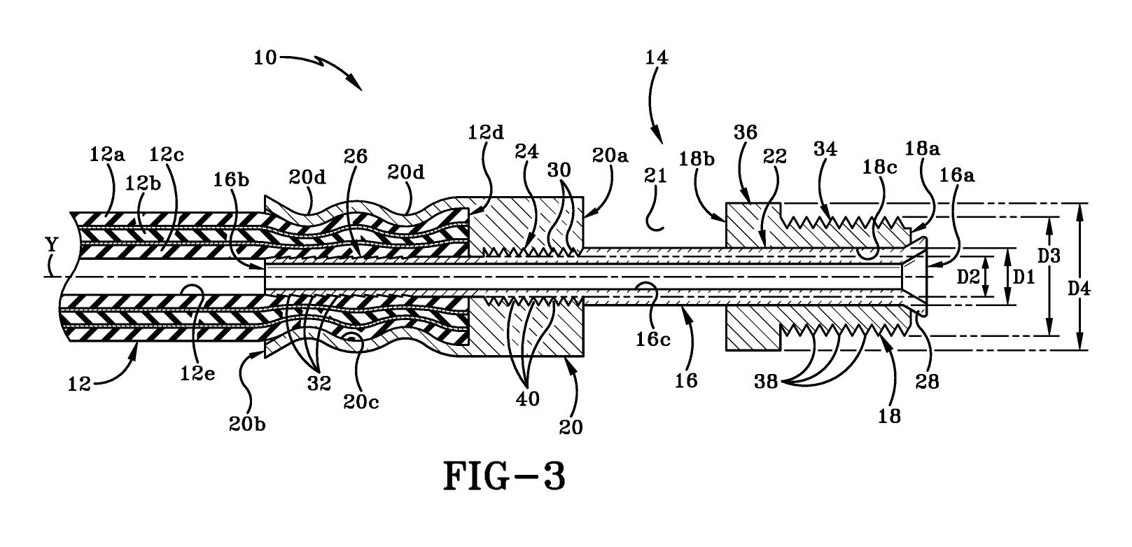

As illustrated in FIG. 3, brake hose 12 is a flexible hose that typically is fabricated from a plurality of concentric tubes such as tubes 12a, 12b, or 12c. Tubes 12a-12c may be fabricated from rubber tubes or as braided, reinforced fiber tubes. It will be understood that any suitable configuration of hose 12 is contemplated to be utilized as part of brake line assembly 10. Innermost tube 12c defines a bore 12e therein that extends from first end 12d (FIG. 3) of hose 12 to the second end thereof (not shown).

Depending on the application of brake line assembly 10, bore 12e may permit the passage of air or brake fluid therethrough. A connector assembly 14 is engaged at each end of hose 12, such as at first end 12d. Hose 12 and connector assembly 14 may therefore be configured to carry air or fluid under pressure. Connector assembly 14 comprises three components, namely, a tube 16, a flare nut 18, and a fitting 20. Fitting 20 is fixedly secured to first end 12d of hose in any suitable manner. One such method of securing fitting 20 and hose 12 together will be described later herein but it will be understood that any suitable method of securing the two components together may be employed. Tube 16 extends outwardly from fitting 20 and flare nut 18 is concentrically engaged with the portion of tube 16 which extends from fitting 20. Flare nut 18 is disposed a spaced distance from fitting 20 and this distance is represented by the reference character “W1” (FIGS. 2 and 5) such that a gap 21 (FIG. 5) is formed between first end 20a of fitting 20 and second end 18b of flare nut 18. The distance “W1” between fitting 20 and second region 36 of flare nut 18 is sufficiently large enough to permit a head of a flare-nut wrench to be received therein. It should be noted that the distance “W1” is substantially larger than the distance “W” of the PRIOR ART device 1 (FIG. 1), which distance “W” was noted as being insufficiently large enough to easily and readily receive a head of a flare-nut wrench therein. Distance “W1” is of a sufficient side to permit a head of a flare-nut wrench therein.

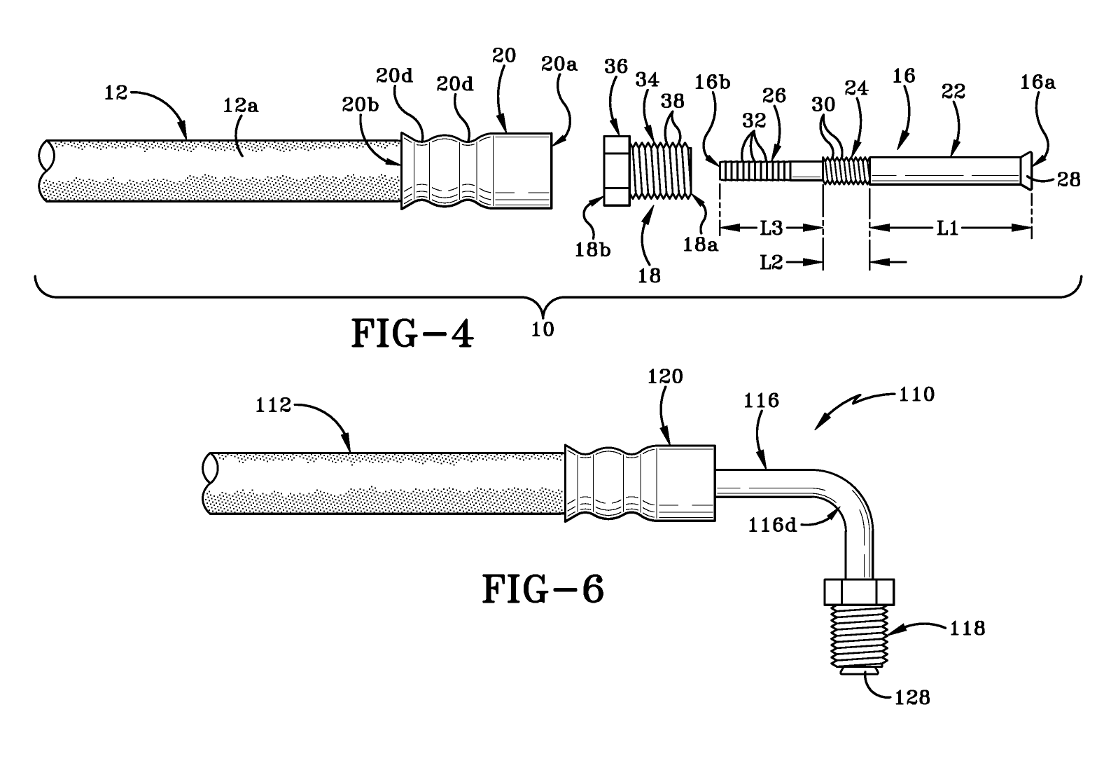

Tube 16 is an elongate tubular member having a first end 16a and a second end 16b and a longitudinal axis “Y” extending therebetween (FIG. 3). As shown in FIGS. 2-4, tube 16 is substantially straight along its length. Tube 16 defines a bore 16c that runs from first end 16a to second end 16b and is open at each end 16a, 16b. FIG. 4 shows that tube 16 includes a first region 22, a second region 24 and a third region 26. Second region 24 is disposed between first and third regions 22, 26. First region 22 is of a length “L1”, second region 24 is of a length “L2”, and third region 26 is of a length “L3”.

FIGS. 3 and 4 show that first region 22 has an exterior surface that is substantially smooth along substantially the entire length “L1”. First region 22 is of an outer diameter “D1” along substantially its entire length “L1” except for the portion proximate first end 16a which is fabricated to include a flare 28. Flare 28 has an outer diameter greater than “D1” for reasons that will be explained later herein.

Second region 24 is also of an outer diameter “D1” and substantially the entire length “L2” of second region is externally threaded with threads 30. Third region 26 is of an outer diameter “D2” that is smaller than outer diameter “D1”. The exterior surface of third region 26 is provided with several projections 32 which extend outwardly therefrom. Substantially the entire length “L3” of third region 26 is provided with projections 32, although this is not essential. Projections 32 may be substantially parallel annular ridges that angle slightly toward the end of tube 16 which includes flare 28. These ridges may be disposed substantially at right angles to longitudinal axis “Y”. Projections 32 are provided so that third region 26 is able to frictionally engage hose 12 and substantially prevent its accidental removal from fitting 20.

Flare nut 18 is a tubular member that has a first end 18a, a second end 18b and defines a bore 18c therein which extends between first and second ends 18a, 18b. Bore 18c is open at each of first and second ends 18a, 18b. Bore 18c is of an interior diameter that is slightly larger than outer diameter “D1” of first region 22 of tube 16. Flare nut 18 is a unitary component which includes a first region 34 and a second region 36. First region 34 is of an exterior diameter “D3” that is greater than diameters “D1” and “D2”; and first region 34 is provided with external threads 38 thereon. Second region 36 is of an exterior diameter “D4” that is greater than diameter “D3”. Second region 36 is hexagonal in cross-section.

Flare nut 18 is engaged with tube 16 by inserting tube 16 through bore 18c of flare nut 18 and flare nut 18 is coaxial with tube 16 when so engaged. Specifically, flare nut 18 is configured to receive first region 22 of tube 16 through bore 18c. Since flare 28 at first end 16a of first region of tube 16 is of a diameter that is greater than diameter “D1”, flare 28 substantially prevents flare nut 18 from sliding off first end 16a of first region 22 of tube 16. It should be noted that flare nut 18 has a length from first end 18a to second end 18b that is about half the length “L1” of first region 22 of tube 16. In other words, first region 22 of tube is about twice as long as flare nut 18. Thus, the distance “W1” is approximately equivalent to the overall length of flare nut 18. This distance “W1” ensures that there is sufficient space between the hexagonal second region 36 of flare nut 18 and fitting 20 to permit a flare-nut wrench (not shown) to be relatively easily engaged with second region 36 during installation or remove of flare nut 18. The open end of the wrench may be slipped over tube 16, substantially at right angles to longitudinal axis “Y”; and then the head of the wrench may be moved longitudinally along tube 16 toward flare nut 18. When the head of the wrench is positioned adjacent second region 36 of flare nut 18 the wrench may be used to rotate the flare nut in either of a first direction or a second direction about the longitudinal axis “Y”.

Tube 16 may be fabricated from stainless steel. Thus, the entire length of tube 16, including flare 28, is less prone to corrosion, especially in humid climates or in regions close to the ocean, or in regions where compounds are used to melt snow. The rest of the connector assembly, i.e., flare nut 18 and fitting 20 may be fabricated from more commonly utilized materials, such as steel or brass. Alternatively, tube 16 may be fabricated from stainless steel and fitting 20 may be fabricated from brass. This combination of materials has been found to be advantageous in that they provide a brake hose assembly that is less prone to corrosion and is stronger than previously known brake hose assemblies. It should be noted that in the instance where the tube 16 is fabricated from stainless steel and the fitting is fabricated from brass, then the engagement between the fitting and the tube is substantially free of brazing or welding.

Fitting 20 has a first end 20a and a second end 20b and defines a bore 20c that extends from first end 20a to second end 20b. Openings to bore 20c are defined in each of first and second ends 20a, 20b. As shown in FIG. 3, bore 20c is of two different interior diameters. A first section of bore 20c proximate first end 20a is configured to be substantially equal in diameter to second region 24 of tube 16. Thus, the first section of bore 20c has an interior diameter which is substantially equal to diameter “D1”. The interior surface of fitting 20 that defines the first section of bore 20c is provided with threads 40 which are configured to threadably engage threads 30 on the exterior surface of second region 24 of tube 16. The engagement of threads 30 and 40 fixedly secures fitting to tube 16. There is thus no need to weld or braze tube 16 to fitting 20 as was done in the prior art devices. It is not economical to braze or silver solder stainless steel tubing to a brass body. The threaded design of the tube 16 and fitting 20 disclosed herein provides a more economical way of engaging these components with each other. The stainless steel tube 16 gives the tube the strength of carbon steel along with the corrosion resistance of brass. The threaded engagement of tube 16 and fitting 20 also prevents relative linear movement between tube 16 and fitting 20 in a direction parallel to longitudinal axis “Y”. The distance between fitting 20 and flare 28 is thus fixed in length and is effectively equivalent to length “L1”. Flare nut 18 is free to move along the length “L1” of first region 22 of tube 16 between flare 28 and first end 20a of fitting 20. This configuration also ensures that there is ample room between fitting 20 and flare nut 18 for the introduction of the head of a flare-nut wrench in order to install or disengage flare nut 18.

The second section of bore 20c in fitting 20 has an interior diameter that is substantially greater than the diameter “D1”. Third region 26 of tube 16 extends through the second section of bore 20c. First end 12d of brake hose 12 is inserted into the opening in second end 20b of fitting 20. As indicated previously, brake hose 12 defines a bore 12e therein and third region 26 of tube 20 is received into bore 12e. Fitting 20 is secured to hose 12 by any suitable means. By way of example only, fitting 20 may be crimped into engagement with hose 12. The crimped regions are identified in FIGS. 2-4 by reference numbers 20d. This crimping action clamps first end 12d of hose 12 between an interior surface of the wall of fitting 20 and the exterior surface of third region 26 of tube 16. First end 12d of hose is thus captured in the second section of bore 20c. Projections 32 on the exterior surface of third region 26 bite into the material of hose 12 and since projections 32 extend toward flare 28, their orientation aids in preventing first end 12d of hose 12 from being withdrawn from bore 20c. It will be understood that other methods of securing the fitting 20 to hose 12 may be utilized instead of crimping.

It will be understood that substantially the entire connector assembly 14 may be fabricated from stainless steel, i.e., the tube 16, flare nut 18, and fitting 20 are all fabricated from stainless steel. The use of a connector assembly that is all fabricated from stainless steel would be especially advantageous in regions where it snows and magnesium salts are utilized by highway departments to melt snow and ice. Magnesium salts are much more corrosive than sodium salts used in the past.

Connector assembly 14 may be used in the following way. If brake hose 12 is to be engaged with, for example, a brake control valve, flare nut 18 is directly threaded into an interiorly threaded aperture in the brake control valve. Flare 28 is placed in contact with an appropriate component in brake control valve. Initially; the mechanic will rotate the flare nut 18 about longitudinal axis “Y” using his or her fingers. Once flare nut 18 has caught, the mechanic will insert a head of a flare nut wrench between fitting 20 and flare nut 20 and over a portion of tube 16. The head of the wrench will be moved toward second region 36. When the head is in the correct position, the head of the wrench will engage second region 36 and will be rotated to rotate flare nut 18 about longitudinal axis “Y” in order to tighten the same. Because of the increased distance “W1” between second region 36 and first end 20a of fitting 20, there is sufficient room for the mechanic to adequately engage flare nut 18 and rotate the same. Similarly if it is desired to remove flare nut 18, the flare-nut wrench can be readily engaged with flare nut 18 because of the increased distance “W1” between flare nut 18 and fitting 20.

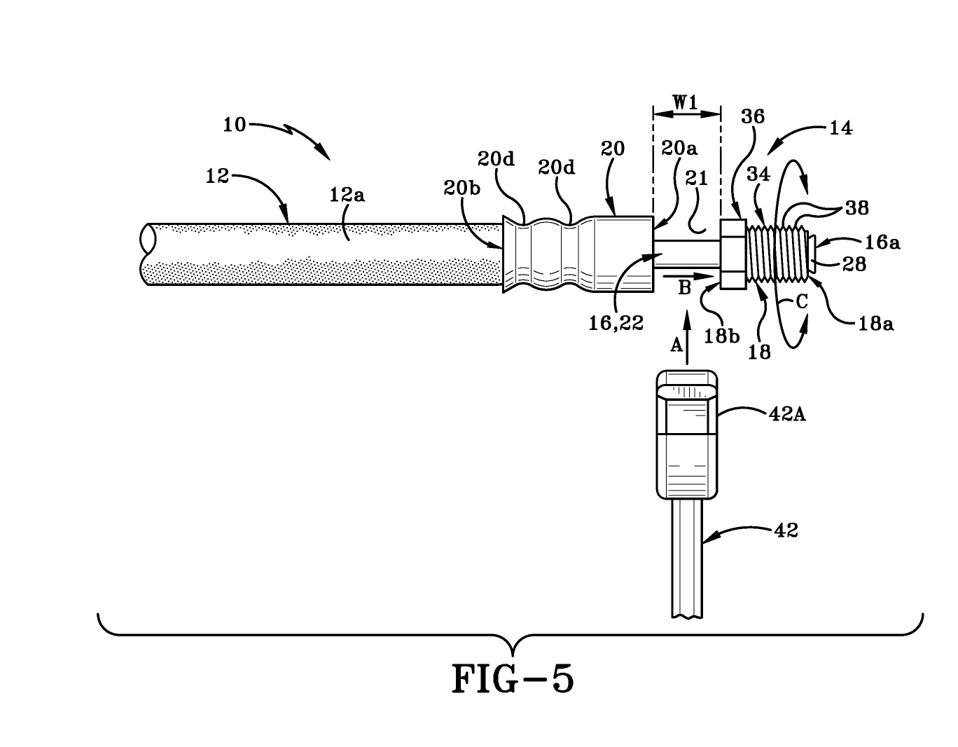

As shown in FIG. 5, there is disclosed a method of securing a brake hose 12 to a component (not shown) of a braking system or disengaging the brake hose therefrom; where brake hose 12 is fixedly engaged with a connector assembly 14 which includes a fitting 20 that is secured to the hose 12, a tube 16 extending outwardly from fitting 20 and terminating in a flare 28, and a flare nut 18 engaged around tube 16 and rotatable about an axis “Y” extending along tube 16. The method comprises the steps of inserting a head 42a of a wrench 42 (either a flare-nut wrench or an open wrench) between a first end 20a of fitting 20 and a second end 18b of flare nut 18; positioning head 42a of wrench 42 adjacent an exterior surface of a length of the tube disposed between first end 20a of fitting 20 and second end 18b of flare nut 18. This is illustrated in FIG. 6 by the downward movement of wrench head 42a in the direction of arrow “A”. The method further includes moving head 42a of wrench 42 toward second end 18b of flare nut 18. This is illustrated in FIG. 6 by arrow “B”. Head 42a of wrench 42 is then engaged with hexagonal region 36 at second end 18b of flare nut 18.

Wrench 42 is used to rotate flare nut 18 in one of two directions about longitudinal axis “Y”. This rotation is indicated by arrow “C” in FIG. 5. Flare nut 18 is rotated in a first direction to secure it to a female component (not shown) of the braking system (such as part of the master cylinder or brake caliper or brake valve, for example. Flare nut 18 is rotated in a second direction to disengage flare nut 18 from the female component.

There is further disclosed a method of attaching a connector assembly 14 to a brake hose 12 to form part of a brake line assembly 10, said method comprising the steps of providing a tube 16 having first and second ends 16a, 16b and defining a bore 16c therebetween, said tube 16 including a first region 22 adjacent first end 16a, a second region 24 adjacent first region 22, and a third region 26 adjacent second region 24; and terminating in second end 16b; a flare nut 18 having first and second ends 18a, 18b and a bore 18c defined therebetween; and a fitting 20 having first and second ends 20a, 20b and a bore 20c defined therebetween; as well as an elongate hose 12 having at least a first end 12a and a bore 12e; inserting first region 22 of tube 16 through first end 18a of flare nut 18 and into flare nut's bore 18c, sliding flare nut 18 along first region 22 of tube 16 until flare nut 18 is disposed adjacent a flare 28 at first end 16a of first region 22 of tube 16; inserting second end 16b of tube 16 into a first end 20a of fitting 20 and into fitting's bore 20c; engaging threads 30 on an exterior surface of second region 24 of tube 16 with threads 40 on an interior surface of fitting 20 defining bore 20c therein; and inserting first end 12a of brake hose 12 into fitting's bore 20c to surround third region 26 of tube 16.

The method further comprising the steps of crimping an exterior surface of fitting 20; and frictionally engaging first end 12a of brake hose 12 between an interior surface of fitting 20 defining bore 20c and an exterior surface of third region 26 of tube 16.

The method may further comprise the step of frictionally engaging first end 12a of brake hose 12 utilizing projections 32 extending outwardly from third region 26 of tube 16.

It will be understood that disengaging the various components described above from each other is accomplished by simply reversing the steps described above.

FIG. 6 shows a second embodiment of a brake line assembly, generally indicated at 110. Brake line assembly 110 includes a hose 112 and a connector assembly 114. Connector assembly 114 includes a tube 116, a flare nut 118 and a fitting 120. Connector assembly 114 is substantially identical in all structure and function to connector assembly 14 except that tube 116 is not straight along substantially its entire length. Instead, tube 116 includes a ninety-degree bend at 116d. A flare 128 is provided at a first end of tube 116 to retain flare nut 118 in engagement with tube 116. Bend 116d is formed in the first region of tube 116, i.e., between flare 128 and the threaded second region (not shown but similar to second region 24 of tube 16) which is threadably engaged with fitting 120. It will be understood that the first region of tube 116 may be substantially longer than the length of flare nut 118 and may be formed to include more than one bend (not shown). Connector assembly 114 is used in a substantially identical manner to connector assembly 14.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example only and the invention is not limited to the exact details shown or described.

1. A brake line assembly for use as part of a braking system, said brake line assembly comprising:
a brake hose having first and second ends and defining a bore therebetween; and
a connector assembly comprising:
a tube having first and second ends and defining a bore therebetween, wherein the first end of the tube includes a flare that is of a greater diameter than the rest of the tube; and wherein a portion of the tube is externally threaded;
a flare nut having first and second ends and a bore defined therebetween; wherein the flare nut is adapted to engage a female component of the braking system; and wherein the tube is received through the flare nut's bore; and
a fitting having first and second ends and a bore defined therebetween, wherein the fitting's bore is configured to receive an end of the brake hose therein; and wherein at least portion of a wall defining the fitting's bore is disposed adjacent the fitting's first end and is internally threaded; and wherein the externally threaded portion of the tube is threadably engaged therewith.

2. The brake line assembly as defined in claim 1, wherein the tube is fabricated from stainless steel and the fitting is fabricated from brass.

3. The brake line assembly as defined in claim 1, wherein the engagement between the fitting and the tube is substantially free of brazing or welding.

4. The brake line assembly as defined in claim 1, wherein the fitting is disposed a distance from the flare when the flare nut is fixedly engaged with the component of the braking system, and wherein the distance between the fitting and the second end of the flare nut is sufficiently large enough to permit a head of a flare-nut wrench to be received therein.

5. The brake line assembly as defined in claim 4, wherein the distance between the fitting and second end of the flare nut is approximately as long as the flare nut's length as measured between the first and second ends of the flare nut.

6. The brake line assembly as defined in claim 1; wherein the tube includes a first region, a second region and a third region; wherein each of the first and second regions is of a first diameter and the third region is of a second diameter that is smaller than the first diameter; and where the second region is disposed intermediate the first and second regions.

7. The brake line assembly as defined in claim 6, wherein the first region of the tube is of a first length and has an exterior surface that is substantially smooth.

8. The brake line assembly as defined in claim 6, wherein the second region of the tube is of a second length and has an exterior surface that comprises the externally threaded portion of the tube.

9. The brake line assembly as defined in claim 6, wherein the third region of the tube is of a third length, and the third region has an exterior surface which includes a plurality of projections which extend outwardly and are adapted to frictionally engage the hose.

10. The brake line assembly as defined in claim 9, wherein the projections comprise substantially parallel annular ridges that angle slightly toward the first end of the tube.

11. The brake line assembly as defined in claim 10, wherein the ridges are disposed substantially at right angles to a longitudinal axis of the tube.

12. The brake line assembly as defined in claim 1, wherein the fitting is crimped onto the hose.

13. The brake line assembly as defined in claim 1, wherein the tube includes a bend.

14. The brake line assembly as defined in claim 6, wherein the tube includes a bend in the first region thereof.

15. The brake line assembly as defined in claim 14, wherein the bend is a 90 degree bend.

16. A method of securing a brake hose to a component of a braking system or disengaging the brake hose therefrom; where the brake hose is fixedly engaged with a connector assembly which includes a brass fitting which is secured to the hose, a stainless steel tube extending outwardly from the fitting and terminating in a flare, and a flare nut engaged around the tube and rotatable about an axis extending along the tube; said method comprising the steps of:
inserting a head of a flare-nut wrench or an open wrench between a first end of the fitting and a second end of the flare nut;
positioning the head of the wrench adjacent an exterior surface of a length of the tube disposed between the first end of the titling and the second end of the flare nut;
moving the head of the wrench toward the second end of the flare nut;
engaging the head of the wrench with a hexagonal region at the second end of the flare nut; and
rotating the flare nut with the wrench about the axis extending through the tube in a first direction to secure the flare nut to the component of the braking system; or in a second direction to disengage the flare nut from the component.

17. A method of attaching a connector assembly to a brake hose to form part of a brake line assembly, said method comprising the steps of;
providing a stainless steel tube having first and second ends and defining a bore therebetween, said tube including a first region adjacent the first end, a second region adjacent the first region, and a third region adjacent the second region and terminating in the second end; a flare nut having first and second ends and a bore defined therebetween; and a brass fitting having first and second ends and a bore defined therebetween; as well as an elongate hose having at least a first end and a bore;
inserting the first region of the tube through the first end of the flare nut and into the flare nut's bore;
sliding the flare nut along the first region of the tube until the flare nut is disposed adjacent a flare at the first end of the first region of the tube;
inserting the second end of the tube into a first end of the fitting and into the fitting's bore;
engaging threads on an exterior surface of the second region of the tube with threads on an interior surface of the fitting defining the bore therein; and
inserting the first end of the brake hose into the fitting's bore to surround the third region of the tube.

18. The method as defined in claim 17, further comprising the steps of:
crimping an exterior surface of the fitting; and
frictionally engaging the first end of the brake hose between an interior surface of the fitting defining the bore and an exterior surface of the third region of the tube.

19. The method as defined in claim 18, further comprising the step of:
frictionally engaging the first end of the brake hose utilizing projections extending outwardly from the third region of the tube.

20. The method as defined in claim 17, wherein the engagement between the fitting and the tube is substantially free of brazing or welding.
